(19) United States
(12) Patent Application Publication
(10) Pub. No.: US 2015/0264288 A1
(43) Pub. Date: Sep. 17, 2015

(54) SOLID-STATE IMAGING DEVICE

(71) Applicant: Kabushiki Kaisha Toshiba, Minato-ku (JP)

(72) Inventor: Ryuta OKAMOTO, Yokohama (JP)

(73) Assignee: Kabushiki Kaisha Toshiba, Minato-ku (JP)

(21) Appl. No.: 14/469,719

(22) Filed: Aug. 27, 2014

(30) Foreign Application Priority Data
Mar. 14, 2014 (JP) 2014-051861

(51) Int. Cl. H04N 5/369; H04N 5/378

(52) U.S. Cl. CPC H04N 5/3698; H04N 5/378

(57) ABSTRACT

According to one embodiment, a pixel array unit has pixels for accumulating photoelectric-converted charges arranged in a matrix, and a drive voltage generation circuit that generates a drive voltage for driving the pixels on driving of the pixels and increases a drive force for generating the drive voltage according to a timing of start of the driving.

### CROSS-REFERENCE TO RELATED APPLICATIONS

This application is based upon and claims the benefit of priority from Japanese Patent Application No. 2014-51861, filed on Mar. 14, 2014; the entire contents of which are incorporated herein by reference.

### FIELD

Embodiments described herein relate generally to a solid-state imaging device.

### BACKGROUND

There is a solid-state imaging device equipped with a charge pump circuit to generate internally a voltage for driving pixels. In order to achieve high-speed driving of the pixels, a drive force for the charge pump circuit is enhanced.

### BRIEF DESCRIPTION OF THE DRAWINGS

FIG. 1 is a schematic block diagram of a functional configuration of a solid-state imaging device according to a first embodiment;

FIG. 2 is a circuit diagram illustrating a configuration example of a pixel in the solid-state imaging device illustrated in FIG. 1;

FIG. 3 is a timing flowchart of voltage waveforms of respective components during pixel reading illustrated in FIG. 1;

FIG. 4 is a block diagram of a configuration example of a drive voltage generation circuit in the solid-state imaging device illustrated in FIG. 1;

FIG. 5 is a timing flowchart of voltage waveforms of a charge pump circuit during operation illustrated in FIG. 4;

FIG. 6A is a circuit diagram illustrating a configuration example of a voltage-dividing unit illustrated in FIG. 4, and FIG. 6B is a circuit diagram illustrating another configuration example of the voltage-dividing unit illustrated in FIG. 4;

FIG. 7A is a circuit diagram illustrating a configuration example of a comparator illustrated in FIG. 4, and FIG. 7B is a circuit diagram illustrating another configuration example of the comparator illustrated in FIG. 4;

FIG. 8A is a circuit diagram illustrating a configuration example of the charge pump circuit illustrated in FIG. 4, and FIG. 8B is a circuit diagram illustrating another configuration example of the charge pump circuit illustrated in FIG. 4;

FIG. 9 is a circuit diagram illustrating a configuration example of a level shifter illustrated in FIG. 4; and

FIG. 10 is a schematic block diagram of a functional configuration of a digital camera to which a solid-state imaging device according to a second embodiment is applied.

### DETAILED DESCRIPTION

In general, according to one embodiment, a solid-state imaging device includes a pixel array unit and a drive voltage generation circuit. The pixel array unit has pixels for accumulating photoelectric-converted charges arranged in a matrix. The drive voltage generation circuit generates a drive voltage for driving the pixels on driving of the pixels, and increases a drive force for generating the drive voltage according to a timing of start of the driving.

Exemplary embodiments of the solid-state imaging device will be explained below in detail with reference to the accompanying drawings. The present invention is not limited to the following embodiments.

### First Embodiment

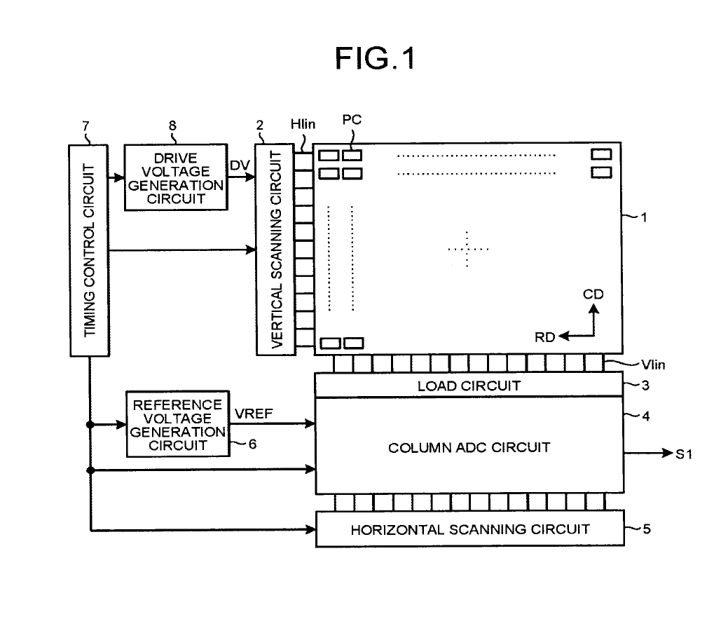

FIG. 1 is a schematic block diagram of a functional configuration of a solid-state imaging device according to a first embodiment.

Referring to FIG. 1, the solid-state imaging device is provided with a pixel array unit 1. The pixel array unit 1 has pixels PC for accumulating photoelectric-converted charges arranged in a matrix of m (m is a positive integer) rows by n (n is a positive integer) columns in row direction RD and column direction CD. The pixel array unit 1 is also provided with horizontal control wires Hlin for controlling reading of the pixels PC in the row direction RD and vertical signal wires Vlin for transmitting signals read from the pixels PC in the column direction CD.

In addition, the solid-state imaging device is provided with a vertical scanning circuit 2 that vertically scans the pixels PC to be read; a load circuit 3 that performs a source follower operation with the pixels PC to read pixel signals from the pixels PC in each of the columns into the vertical signal wires Vlin; a column ADC circuit 4 that detects by CDS signal components of the pixels PC in each of the columns; a horizontal scanning circuit 5 that horizontally scans the pixels PC to be read; a reference voltage generation circuit 6 that outputs a reference voltage VREF to the column ADC circuit 4; a timing control circuit 7 that controls reading of the pixels PC and timing of accumulation; and a drive voltage generation circuit 8 that generates a drive voltage DV for driving the pixels PC on driving of the pixels PC. The drive voltage generation circuit 8 can increase a drive force for generating the drive voltage DV according to a timing of start of driving of the pixels PC. The reference voltage VREF can use a ramp wave.

Then, when the pixels PC are vertically scanned by the vertical scanning circuit 2, the pixels PC are selected in the row direction RD, and the drive voltage DV generated by the drive voltage generation circuit 8 is supplied to the pixels PC. Then, at the load circuit 3, when a source follower operation is performed with the pixels PC, the pixel signals read from the pixels PC are transmitted to the column ADC circuit 4 via the vertical signal wires Vlin. In addition, at the reference voltage generation circuit 6, a ramp wave is set as reference voltage VREF and sent to the column ADC circuit 4. Then, at the column ADC circuit 4, a clock count operation is performed until the signal level and the reset level read from the pixels PC agree with the level of the ramp wave, and a difference is determined between the signal level and the reset level at that time to detect the signal components of the pixels PC by CDS, and the signal components are output as an output signal S1.

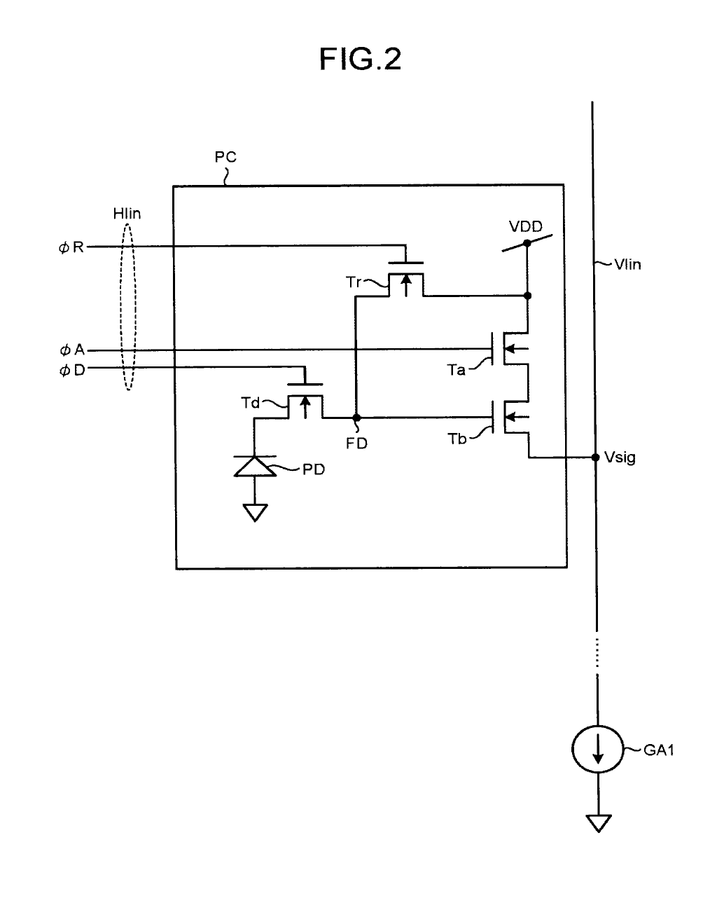

FIG. 2 is a circuit diagram illustrating a configuration example of a pixel in the solid-state imaging device illustrated in FIG. 1.

Referring to FIG. 2, each of the pixels PC is provided with a photodiode PD, a row selection transistor Ta, an amplification transistor Tb, a reset transistor Tr, and a read transistor Td. A floating diffusion FD is formed as a detection node at a connection point of the amplification transistor Tb, the reset transistor Tr, and the read transistor Td.

In the pixel PC, a source of the read transistor Td is connected to the photodiode PD, and a read signal ΦD is input into a gate of the read transistor Td. A source of the reset transistor Tr is connected to a drain of the read transistor Td, a reset signal ΦR is input into a gate of the reset transistor Tr, and a drain of the reset transistor Tr is connected to a power source potential VDD. A row selection signal ΦA is input into a gate of the row selection transistor Ta, and a drain of the row selection transistor Ta is connected to the power source potential VDD. A source of the amplification transistor Tb is connected to the vertical signal wire Vlin, a gate of the amplification transistor Tb is connected to a drain of the read transistor Td, and a drain of the amplification transistor Tb is connected to a source of the row selection transistor Ta. The horizontal control wires Hlin illustrated in FIG. 1 can transmit the read signal ΦD, the reset signal ΦR, and the row selection signal ΦA to the pixels PC in each of the rows. Constant current source GA1 is provided to the load circuit 3 illustrated in FIG. 1 in each of the columns. The constant current source GA1 is connected to the vertical signal wire Vlin. The drive voltage DV can be used as a pulse voltage of the row selection signal ΦA, the read signal ΦD, and the reset signal ΦR.

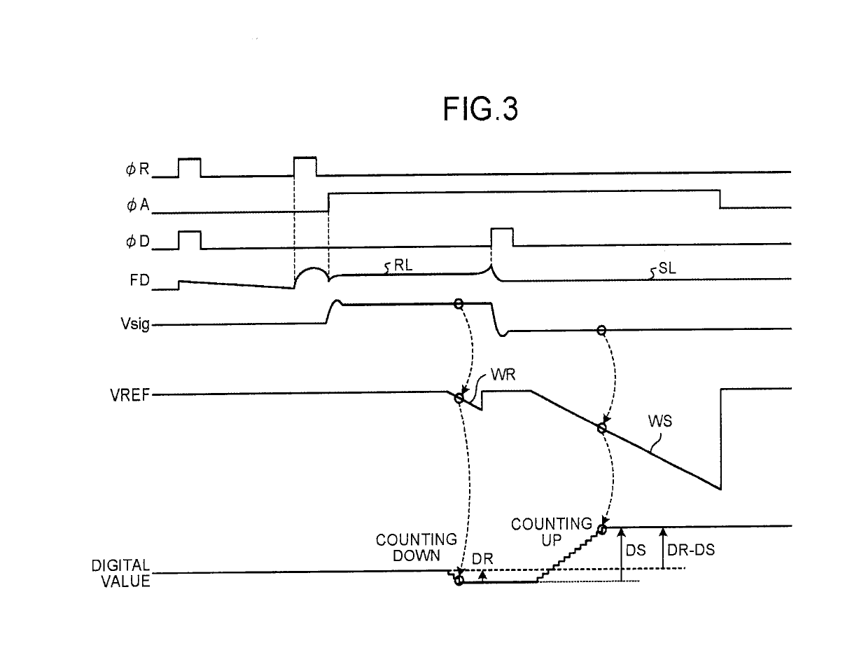

FIG. 3 is a timing flowchart of voltage waveforms of respective components during pixel reading illustrated in FIG. 1.

Referring to FIG. 3, in the case where the row selection signal ΦA is in low level, the row selection transistor Ta is in off state and does not perform a source follower operation, and thus no signal is output to the vertical signal wires Vlin. At that time, if the read signal ΦD and the reset signal ΦR become high, the read transistor Td is turned on to emit charges accumulated in the photodiode PD to the floating diffusion FD. Then, the charges are emitted to the power source potential VDD via the reset transistor Tr.

After the charges accumulated in the photodiode PD are emitted to the power source potential VDD, when the read signal ΦD becomes low, accumulation of effective signal charges is started in the photodiode PD.

Next, on the rising edge of the reset signal ΦR, the reset transistor Tr is turned on to reset excessive charges resulting from leak current or the like in the floating diffusion FD.

Then, when the row selection signal ΦA becomes high, the row selection transistor Ta of the pixel PC is turned on, and then the power source potential VDD is applied to the drain of the amplification transistor Tb, whereby a source follower circuit is formed by the amplification transistor Tb and the constant current source GA1. Then, a voltage corresponding to a reset level RL of the floating diffusion ED is applied to the gate of the amplification transistor Tb. Since the source follower circuit is formed by the amplification transistor Tb and the constant current source GA1, the voltage of the vertical signal wire Vlin follows the voltage applied to the gate of the amplification transistor Tb, and a pixel signal Vsig according to the reset level RL is output to the column ADC circuit 4 via the vertical signal wire Vlin. In addition, the reset level RL and the pixel signal Vsig according to the reset level RL behave in the same manner from the viewpoint of voltage change, but have therebetween a difference equivalent to a threshold voltage of the amplification transistor Tb.

At that time, a ramp wave WR is given as reference voltage VREF to compare the pixel signal Vsig of the reset level RL with the reference voltage VREF. Then, the pixel signal Vsig of the reset level RL is counted down until the reset level RL of the pixel signal Vsig agrees with the level of the reference voltage VREF, whereby the pixel signal Vsig of the reset level RL is converted into a digital value DR and held as such.

Next, on the rising edge of the read signal ΦD, the read transistor Td is turned on to transfer the charges accumulated in the photodiode PD to the floating diffusion ED and apply a voltage corresponding to a signal level SL of the floating diffusion FD to the gate of the amplification transistor Tb. Since the source follower circuit is formed by the amplification transistor Tb and the constant current source GA1, the voltage of the vertical signal wire Vlin follows the voltage applied to the gate of the amplification transistor Tb, and a pixel signal Vsig of the signal level SL is output to the column ADC circuit 4 via the vertical signal wire Vlin.

At that time, a ramp wave WS is given as reference voltage VREF, and the pixel signal Vsig of the signal level SL is compared to the reference voltage VREF. Then, the pixel signal Vsig of the signal level SL is counted up until the level of the pixel signal Vsig agrees with the level of the reference voltage VREF, whereby the pixel signal Vsig of the signal level SL is converted into a digital value DS. Then, a difference DR-DS between the pixel signal Vsig of the reset level RL and the pixel signal Vsig of the signal level SL is held and output as an output signal S1.

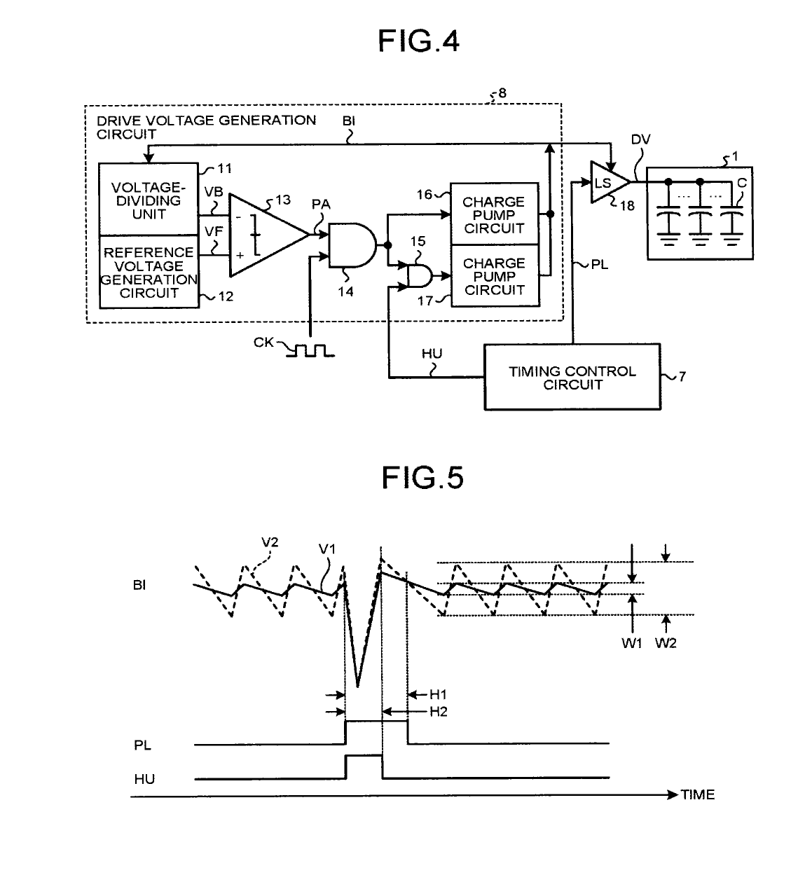

FIG. 4 is a block diagram of a configuration example of a drive voltage generation circuit in the solid-state imaging device illustrated in FIG. 1. In the pixel array unit 1 illustrated in FIG. 4, the pixels PC are represented by capacities C. In addition, in the pixel array unit 1 illustrated in FIG. 4, the pixels PC are represented in one row. If the drive voltage DV is used as a pulse voltage of the row selection signal A, the capacity C constitutes a gate capacity of the row selection transistor Ta. If the drive voltage DV is used as a pulse voltage of the read signal ΦD, the capacity C constitutes a gate capacity of the read transistor Td. If the drive voltage DV is used as a pulse voltage of the reset signal ΦR, the capacity C constitutes a gate capacity of the reset transistor Tr.

Referring to FIG. 4, the drive voltage generation circuit 8 is provided with a voltage-dividing circuit 11, a reference voltage generation circuit 12, a comparator 13, AND circuits 14 and 15, and charge pump circuits 16 and 17. The drive voltage generation circuit 8 is connected to the pixel array unit 1 via a level shifter 18. The voltage-dividing circuit 11 divides a bias voltage PT output from the charge pump circuits 16 and 17. The reference voltage generation circuit 12 generates a reference voltage VF. The comparator 13 compares a divided voltage VB generated at the voltage-dividing circuit 11 to the reference voltage VF. The AND circuit 14 outputs a clock CK to the charge pump circuit 16 and the AND circuit 15 according to an output PA of the comparator 13. The AND circuit 15 outputs an output of the AND circuit 14 to the charge pump circuit 17 according to a timing of start of driving of the pixels PC. The charge pump circuit 16 is operated according to its output voltage. The drive force for the charge pump circuit 16 can be set so as to compensate for a voltage increase due to discharge from the pixels PC. The charge pump circuit 17 is operated at start of driving of the pixels PC. The drive force for the charge pump circuit 17 can be set so as to make shorter a rising time of the drive voltage DV at start of driving of the pixels PC. The level shifter 18 transfers the bias voltage BI as the drive voltage DV to the pixel array unit 1 on driving of the pixels PC. The level shifter 18 can be provided in each of the rows. The level shifter 18 can be provided separately for resetting and reading. The timing control circuit 7 outputs a timing control signal PL to the level shifter 18, and outputs a timing control signal HU to the charge pump circuit 17.

Then, the bias voltage BI output from the charge pump circuits 16 and 17 is divided at the voltage-dividing circuit 11 and output to the comparator 13. The reference voltage VF generated at the reference voltage generation circuit 12 is output to the comparator 13. The reference voltage VF can be set to about 1 V, for example. The bias voltage BI can be set to 3.5 V or higher, for example. When the divided voltage VB generated at the voltage-dividing circuit 11 falls below the reference voltage VP, an output PA of the comparator 13 rises, and the clock CK is supplied from the AND circuit 14 to the charge pump circuit 16 and the AND circuit 15. When the clock CK is supplied to the charge pump circuit 16, the charge pump circuit 16 is driven to perform an operation for raising the bias voltage BI. In addition, while the divided voltage VB generated at the voltage-dividing circuit 11 is below the reference voltage VF, when the timing reference signal HU rises, the clock CK is supplied from the AND circuit 15 to the charge pump circuit 17. When the clock CK is supplied to the charge pump circuit 17, the charge pump circuit 17 is driven to perform an operation for raising the bias voltage BI.

Then, as a result of the operation for raising the bias voltage BI, when the divided voltage VB generated at the voltage-dividing circuit 11 exceeds the reference voltage VF, the output PA of the comparator 13 falls to stop the supply of the clock CK from the AND circuit 14.

In addition, when the pixels PC are driven, the timing control signal PL rises. As a result, the drive voltage DV is shifted to the bias voltage BI and supplied to the pixels PC. At that time, since the capacity C is charged by the drive voltage DV, the drive voltage DV decreases. When the drive voltage DV decreases and the divided voltage VB generated at the voltage-dividing circuit 11 falls below the reference voltage VF, the output PA of the comparator 13 rises. Accordingly, the clock CK is supplied to the charge pump circuit 16 to perform an operation for raising the bias voltage BI. In addition, when the timing control signal HU rises at the timing of rise of the timing control signal PL, the clock CK is supplied to the charge pump circuit 17, and the charge pump circuit 17 cooperates with the charge pump circuit 16 to perform the operation for raising the bias voltage BI.

Since the charge pump circuits 16 and 17 cooperate to perform the operation for raising the bias voltage BI at start of driving of the pixels PC, it is possible to shorten the rising time of the drive voltage DV and thus realise high-speed driving of the pixels PC. In addition, it is possible to stop the charge pump circuit 17 and drive only the charge pump circuit 16 at a timing close to the rise of the drive voltage DV at start of driving of the pixels PC. At that time, the charge pump circuit 17 can be provided with a drive force necessary to shorten the rising time of the drive voltage DV at start of driving of the pixels PC. Thus, the drive force for the charge pump circuit 16 may be set only so as to compensate for a voltage decrease due to discharge from the pixels PC. This allows the drive force for the charge pump circuit 16 to be lowered as compared to the case where the charge pump circuit 16 is provided with a drive force necessary to shorten the rising time of the drive voltage DV at start of driving of the pixels PC. As a result, it is possible to reduce noise resulting from a ripple of the charge pump circuit 16 and thus reduce noise after start of driving of the pixels PC.

FIG. 5 is a timing flowchart of voltage waveforms of a charge pump circuit during operation illustrated in FIG. 4. In the drawing, reference numeral V1 denotes a waveform with addition of the charge pump circuit 17 to the charge pump circuit 16, and reference numeral V2 denotes a waveform without addition of the charge pump circuit 17 to the charge pump circuit 16.

Referring to FIG. 5, when the charge pump circuits 16 and 17 are driven, a ripple W1 occurs in the bias voltage BI. Meanwhile, in the absence of the charge pump circuit 17, it is necessary to increase a drive force for the charge pump circuit 16 as compared to the case in the presence of the charge pump circuit 17 to set the same rising time as that in the presence of the charge pump circuit 17 at start of driving of the pixels PC (at rising edge of the timing control signal Pt). Accordingly, a ripple W2 greater the ripple W1 occurs in the bias voltage BI.

At that time, pulse width H2 of the timing control signal HU can be made shorter than pulse width H1 of the timing control signal PL. Accordingly, it is possible to lower the timing control signal HU before falling of the timing control signal PL, and thus reduce influence of increase in the ripple W1 due to driving of the charge pump circuit 17.

In addition, by providing the AND circuit 15 at former stage of the charge pump circuit 17, if the divided voltage VS generated at the voltage-dividing circuit 11 exceeds the reference voltage VF before falling of the timing control signal HU, it is possible to stop the voltage raising operation of the charge pump circuit 17 before falling of the timing control signal HU, and thus reduce influence of increase of the ripple W1 due to driving of the charge pump circuit 17.

The timing for rising of the timing control signal HU may be delayed or advanced with respect to the timing for rising of the row selection signal ΦA, the read signal ΦD, or the reset signal ΦR by a predetermined number of clocks. In addition, the timing for falling of the timing control signal HU may be delayed or advanced with respect to the row selection signal ΦA, the read signal ΦD, or the reset signal ΦR by a predetermined number of clocks.

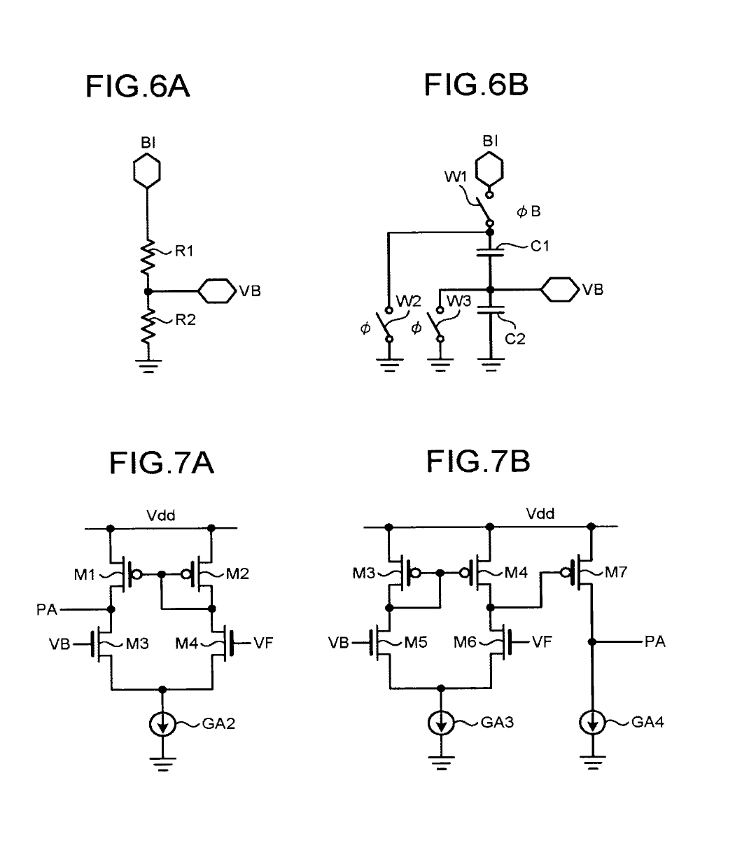

FIG. 6A is a circuit diagram illustrating a configuration example of a voltage-dividing unit illustrated in FIG. 4, and FIG. 6B is a circuit diagram illustrating another configuration example of the voltage-dividing unit illustrated in FIG. 4.

Referring to FIG. 6A, the voltage-dividing unit is provided with resistors R1 and R2 that are connected in series to each other. When the bias voltage BI is applied to one end of the resistor R1, the bias voltage BI is divided at the resistors R1 and R2, and a divided voltage VB is output from a connection point between the resistors R1 and R2.

Referring to FIG. 6B, the voltage-dividing unit is provided with capacities C1 and C2 and switches W1 to W3. The capacities C1 and C2 are connected in series to each other. The switch W1 is connected between the bias voltage BI and the capacity C1. The switch W3 is connected in parallel to the capacity C2. The switch W2 is connected in parallel to the series circuit of the capacities C1 and C2.

Then, a signal Φ is applied to the switches W2 and W3, and a signal ΦB is applied to the switch W1. The signal ΦB is an inverted signal of the signal Φ. In addition, at rising edge of the signal Φ, the switch W1 is turned off and the switches W2 and W3 are turned on to reset the capacities C1 and C2. Then, at falling edge of the signal Φ, the switch W1 is turned on and the switches W2 and W3 are turned off. Then, when the bias voltage BI is applied to one end of the capacity C1, the bias voltage BI is divided at the capacities C1 and C2, and a divided voltage VD is output from the connection point between the capacities C1 and C2.

FIG. 7A is a circuit diagram illustrating a configuration example of a comparator illustrated in FIG. 4, and FIG. 7B is a circuit diagram illustrating another configuration example of the comparator illustrated in FIG. 4.

Referring to FIG. 7A, the comparator is provided with P-channel transistors M1 and M2, N-channel transistors M3 and M4, and a current source GA2. The P-channel transistor M1 and the N-channel transistor M3 are connected in series to each other, and the P-channel transistor M2 and the N-channel transistor M4 are connected in series to each other. Sources of the N-channel transistors M3 and M4 are connected to a current source GA2. Gates of the P-channel transistors M1 and M2 are connected to a drain of the N-channel transistor M4.

The divided voltage VB is applied to a gate of the N-channel transistor M3, and the reference voltage VF is applied to a gate of the N-channel transistor M4. In addition, when the divided voltage VB exceeds the reference voltage VF, the N-channel transistor M3 is turned on and the N-channel transistor M4 is turned off. As a result, the output PA of the comparator 13 is grounded via the N-channel transistor M3, and the output. PA of the comparator 13 falls. Meanwhile, when the divided voltage VP falls below the reference voltage VF, the N-channel transistor M3 is turned off, and the N-channel transistor M4 is turned on. As a result, the P-channel transistors M1 and M2 are turned on, and the output PA of the comparator 13 is connected to a power source potential Vdd via the P-channel transistor M1, and the output PA of the comparator 13 rises.

Referring to FIG. 7B, the comparator is provided with P-channel transistors M3, M4, and M7, N-channel transistors M5 and M6, and current sources GA3 and GA4. The P-channel transistor M3 and the N-channel transistor M5 are connected in series to each other, and the P-channel transistor M4 and the N-channel transistor M6 are connected in series to each other. Sources of the N-channel transistor M5 and M6 are connected to the current source GA3. Gates of the P-channel transistors M3 and M4 are connected to a drain of the N-channel transistor M5. A gate of the P-channel transistor M7 is connected to a drain of the N-channel transistor M6. A drain of the P-channel transistor M7 is connected to the current source GA4.

The divided voltage VB is applied to a gate of the N-channel transistor M5, and the reference voltage VF is applied to a gate of the N-channel transistor M6. In addition, when the divided voltage VP exceeds the reference voltage VF, the N-channel transistor M6 is turned off, and the N-channel transistor M5 is turned on. As a result, the P-channel transistor M4 is turned on, the P-channel transistor M7 is turned off, and the output PA of the comparator 13 falls. Meanwhile, when the divided voltage VB falls below the reference voltage VF, the N-channel transistor M6 is turned on and the N-channel transistor M5 is turned off. As a result, the P-channel transistor M7 is turned on, the output PA of the comparator 13 is connected to the power source potential Vdd via the P-channel transistor M7, and the output PA of the comparator 13 rises.

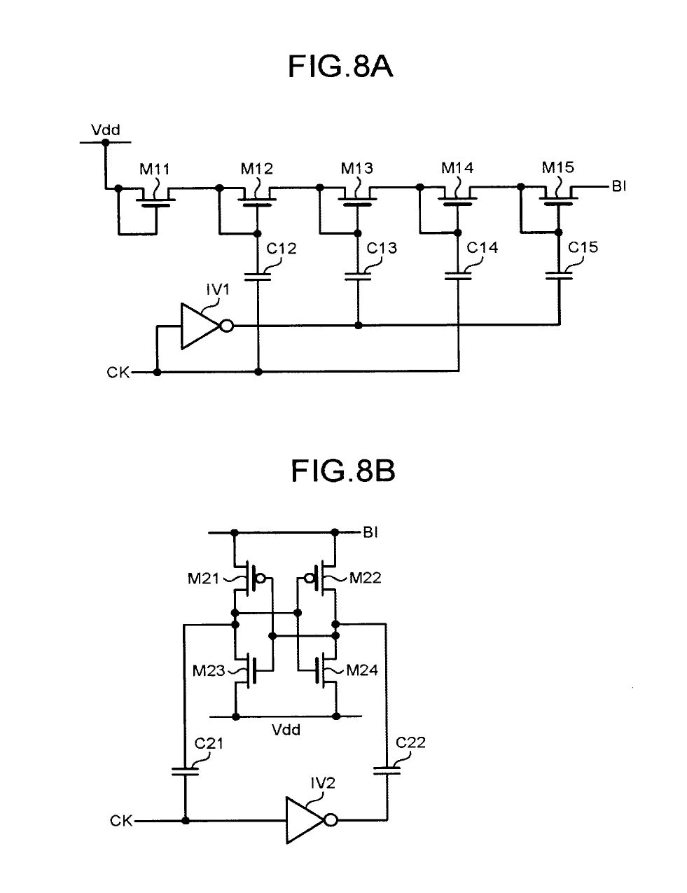

FIG. 8A is a circuit diagram illustrating a configuration example of the charge pump circuit illustrated in FIG. 4, and FIG. 8B is a circuit diagram illustrating another configuration example of the charge pump circuit illustrated in FIG. 4.

Referring to FIG. 8A, the charge pump circuit is provided with N-channel transistors M11 to M15, capacities C12 to C15, and an inverter IV1. The N-channel transistors M11 to M15 are connected in series to one another. Gates of the N-channel transistor M11 to M15 are connected to drains to drains of the N-channel transistor M11 to M15, respectively.

The clock OK is applied to gates of the N-channel transistors M12 and M14 via the capacities C12 and C14 respectively, and the clock CK is applied to gates of the N-channel transistors M13 and M15 via the inverter IV1 and the capacities C13 and C15, respectively. Then, since the power source potential Vdd is applied to a gate of the N-channel transistor M11, the N-channel transistor M11 is turned on and the capacity C12 is charged up to a power source potential Vdd-Vth, where Vth denotes a threshold voltage of the N-channel transistor M11. Then, when the clock CK rises, the N-channel transistors M12 and M14 are turned on, and charges filled in the capacities C12 and C14 are transmitted to the capacities C13 and C15 via the N-channel transistors M12 and M14, respectively. Meanwhile, when the clock CK falls, the N-channel transistors M13 and M15 are turned on, charges filled in the capacity C13 are transmitted to the capacity C14 via the N-channel transistor M13, and the voltage of the capacity C15 is output as the bias voltage BI.

Referring to FIG. 83, the charge pump circuit is provided with P-channel transistors M21 and M22, N-channel transistor M23 and M24, capacities C21 and C22, and an inverter IV2. The P-channel transistor M21 and the N-channel transistor M23 are connected in series to each other, and the P-channel transistor M22 and the N-channel transistor M24 are connected in series to each other. Gates of the P-channel transistor M21 and the N-channel transistor M23 are connected to drains of the P-channel transistor M22 and the N-channel transistor M24, and gates of the P-channel transistor M22 and the N-channel transistor M24 are connected to drains of the P-channel transistor M21 and the N-channel transistor M23.

The clock CK is applied to the gates of the P-channel transistor M21 and the N-channel transistor M23 via the capacity C22, the clock CK is applied to the gates of the P-channel transistor M22 and the N-channel transistor M24 via the inverter IV2 the capacity C21. Then, when the clock OK rises, the P-channel transistor M21 and the N-channel transistor M24 are turned on, and the P-channel transistor M22 and the N-channel transistor M23 are turned off. As a result, the capacity C22 is charged up to the power source potential Vdd via the N-channel transistor M24. Meanwhile, when the clock CK falls, the P-channel transistor M21 and the N-channel transistor M24 are turned off, and the P-channel transistor M22 and the N-channel transistor M23 are turned on. As a result, the capacity C21 is charged up to the power source potential Vdd via the N-channel transistor M23.

When the clock CK rises in the state where the capacity C21 is charged up to the power source potential Vdd, the P-channel transistor M21 is turned on and the N-channel transistor M23 is turned off. As a result, a voltage with the level of the clock CK increased by the power source potential Vdd is output as the bias voltage BI from a source of the P-channel transistor M21. In addition, when the clock CK falls in the state where the capacity C22 is charged up to the power source potential Vdd, the P-channel transistor M22 is turned on and the N-channel transistor M24 is turned off. As a result, a voltage with the level of the clock CK increased by the power source potential Vdd is output as the bias voltage BI from a source of the P-channel transistor M22.

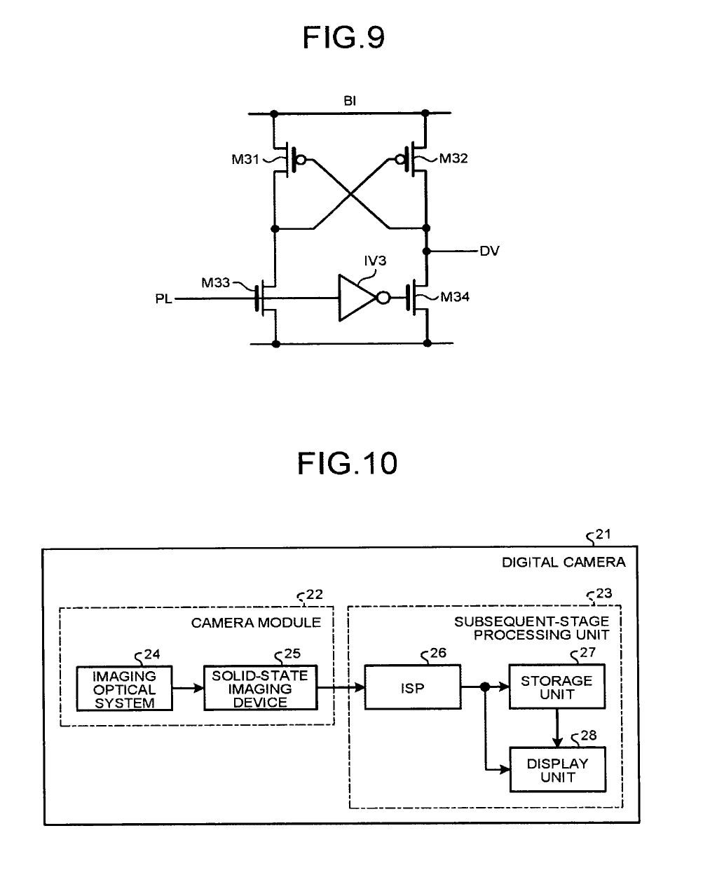

FIG. 9 is a circuit diagram illustrating a configuration example of a level shifter illustrated in FIG. 4.

Referring to FIG. 9, the level shifter is provided with P-channel transistors M31 and M32, N-channel transistors M33 and M34, and an inverter IV3. The P-channel transistor M31 and the N-channel transistor M33 are connected in series to each other, and the P-channel transistor M32 and the N-channel transistor M34 are connected in series to each other. A gate of the P-channel transistor M31 is connected to a drain of the N-channel transistor M34, and a gate of the P-channel transistor M32 is connected to a drain of the N-channel transistor M33.

The bias voltage BI is applied to sources of the P-channel transistors M31 and M32. The timing control signal PL is applied to a gate of the N-channel transistor M33, and the timing control signal PL is applied to a gate of the N-channel transistor M34 via the inverter IV3. Then, when the timing control signal PL rises, the N-channel transistor M33 is turned on and the N-channel transistor M34 is turned off. As a result, the gate of the P-channel transistor M32 is grounded via the N-channel transistor M33, and the P-channel transistor M32 is turned on. Accordingly, the bias voltage BI is transferred as the drive voltage DV, and the P-channel transistor M31 is turned off. Meanwhile, when the timing control signal PL falls, the N-channel transistor M33 is turned off and the N-channel transistor M34 is turned on. As a result, the drive voltage DV is shifted to the ground voltage, the P-channel transistor M31 is turned on and the P-channel transistor M32 is turned off.

### Second Embodiment

FIG. 10 is a schematic block diagram of a functional configuration of a digital camera to which a solid-state imaging device according to a second embodiment is applied.

Referring to FIG. 10, a digital camera 21 has a camera module 22 and a subsequent-stage processing unit 23. The camera module 22 has an imaging optical system 24 and a solid-state imaging device 25. The subsequent-stage processing unit 23 has an image signal processor (ISP) 26, a storage unit 27, and a display unit 28. The solid-state imaging device 25 may have the configuration illustrated in FIG. 1. At least portion of the ISP 26 may be configured to form one chip together with the solid-state imaging device 25.

The imaging optical system 24 captures light from a subject and forms an image of the subject. The solid-state imaging device 25 takes the image of the subject. The ISP 26 processes an image signal obtained from the imaging at the solid-state imaging device 25. The storage unit 27 stores the image having undergone the signal processing at the ISP 26. The storage unit 27 outputs the image signal to the display unit 28 according to the user's operation or the like. The display unit 28 displays the image according to the image signal input from the ISP 26 or the storage unit 27. The display unit 28 is a liquid crystal display, for example. The camera module 22 may be applied to not only the digital camera 21 but also electronic devices such as a camera-equipped mobile phone or a smart phone, for example.

In addition, the foregoing solid-state imaging device may be formed on a semiconductor chip of a single-layered structure or may be formed on a semiconductor chip of a multilayered structure.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device, comprising:
a pixel array unit in which pixels for accumulating photoelectric-converted charges are arranged in a matrix; and
a drive voltage generation circuit that generates a drive voltage for driving the pixels on driving of the pixels and increases a drive force for generating the drive voltage according to a timing of start of the driving.

2. The solid-state imaging device according to claim 1, wherein
the drive voltage generation circuit includes:
a first charge pump circuit that is operated according to an output voltage thereof; and
a second charge pump circuit that is operated at start of the driving.

3. The solid-state imaging device according to claim 2, wherein
a drive force for the first charge pump circuit is set so as to compensate for a voltage decrease due to discharge from the pixels.

4. The solid-state imaging device according to claim 3, wherein a drive force for the second charge pump circuit is set such that a rising time of the drive voltage at start of driving of the pixels becomes shorter as compared to the case where the pixels are driven only by the first charge pump circuit.

5. The solid-state imaging device according to claim 2, wherein, when the drive voltage rises at start of driving of the pixels, the second charge pump circuit is stopped and only the first charge pump circuit is driven.

6. The solid-state imaging device according to claim 2, wherein, at start of driving of the pixels, the first charge pump circuit and the second charge pump circuit cooperate to perform a voltage raising operation.

7. The solid-state imaging device according to claim 1, comprising a timing control circuit that controls a timing of start of the driving.

8. The solid-state imaging device according to claim 1, wherein each of the pixels includes:
a photodiode that accumulates photoelectric-converted charges;
a row selection transistor that selects the pixels in a row selection;
an amplification transistor that detects a signal read from the photodiode;
a reset transistor that resets a signal read from the photodiode; and
a read transistor that reads a signal from the photodiode.

9. The solid-state imaging device according to claim 8, comprising a vertical scanning circuit that vertically scans pixels to be read.

10. The solid-state imaging device according to claim 9, wherein the vertical scanning circuit inputs a row selection signal to a gate of the row selection transistor, inputs a read signal to a gate of the read transistor, and inputs a reset signal to a gate of the reset transistor.

11. The solid-state imaging device according to claim 10, wherein the drive voltage is used as a pulse voltage of the row selection signal.

12. The solid-state imaging device according to claim 10, wherein the drive voltage is used as a pulse voltage of the read signal.

13. The solid-state imaging device according to claim 10, wherein the drive voltage is used as a pulse voltage of the reset signal.

14. The solid-state imaging device according to claim 1, wherein the drive voltage generation circuit includes:
a first charge pump circuit;
a second charge pump circuit;
a voltage-dividing unit that divides a bias voltage output from the first charge pump circuit and the second charge pump circuit;
a reference voltage generation circuit that generates a reference voltage;
a comparator that compares the divided voltage generated at the voltage-dividing unit to the reference voltage;
a first AND circuit that outputs a clock to the first charge pump circuit based on results of the comparison by the comparator; and
a second AND circuit that outputs an output of the first AND circuit to the second charge pump circuit according to a timing of start of the driving.

15. The solid-state imaging device according to claim 14, wherein a drive force for the first charge pump circuit is set so as to compensate for a voltage decrease due to discharge from the pixels.

16. The solid-state imaging device according to claim 15, wherein a drive force for the second charge pump circuit is set such that a rising time of the drive voltage at start of driving of the pixels becomes shorter as compared to the case where the pixels are driven only by the first charge pump circuit.

17. The solid-state imaging device according to claim 14, wherein, when the drive voltage rises at start of driving of the pixels, the second charge pump circuit is stopped and only the first charge pump circuit is driven.

18. The solid-state imaging device according to claim 14, wherein, at start of driving of the pixels, the first charge pump circuit and the second charge pump circuit cooperate to perform a voltage raising operation of the bias voltage.

19. The solid-state imaging device according to claim 14, comprising a timing control circuit that controls a timing of start of the driving.

20. The solid-state imaging device according to claim 19, further comprising a level shifter that shifts the drive voltage to the bias voltage on driving of the pixels, wherein
the timing control circuit drives the second charge pump circuit at a timing of supplying the drive voltage from the level shifter to the pixels, and stops the second charge pump circuit before the supply of the drive voltage from the level shifter to the pixels is stopped.
